(19) United States
(12) Patent Application Publication
(10) Pub. No.: US 2006/0184736 A1
(43) Pub. Date: Aug. 17, 2006

(54) Apparatus, system, and method for storing modified data

(76) Inventors: Michael Thomas Benhase, Tucson, AZ (US); Matthew Joseph Kalos, Tucson, AZ (US); Carol Spanel, San Jose, CA (US); Andrew Dale Walls, San Jose, CA (US)

Correspondence Address: KUNZLER & ASSOCIATES, 8 EAST BROADWAY, SUITE 600, SALT LAKE CITY, UT, 84111, US

(21) Appl. No.: 11/061,187

(22) Filed: Feb. 17, 2005

(51) Int. Cl. G06F 12/14

(52) U.S. Cl. 711/118

(57) ABSTRACT

An apparatus, system and method are disclosed for storing modified data. The apparatus includes a battery source for supplying backup power. The apparatus also includes a memory module for storing data. The memory module includes a backup portion and a non-backup portion. Only the backup portion is backed up by the battery source in the event of a power failure. A data flow module controls data flow into and out of the memory module. The data flow module stores modified data exclusively in the backup portion of the memory module.

### BACKGROUND OF THE INVENTION

1. Field of the Invention

This invention relates to storing modified data and more particularly relates to storing modified write command data to cache on a predetermined portion of memory backed up by a battery without having to have all of memory non-volatile.

2. Description of the Related Art

At the start of applications, data and instructions are moved from the computer's hard disk, which processes relatively slowly, into the computer's main memory. A computer's main memory is typically made up of dynamic random access memory (“DRAM”), which has a faster access time than disk drives in part because the computer's central processing unit (“CPU”) can get to it more quickly. However, to increase the processing speed of computers, shorter-term memory called memory caches (“caches”) are used.

A cache is a portion of memory made of high-speed static random access memory (“SRAM”) instead of the slower and cheaper DRAM used for the computer's main memory. The concept of caching is based upon the fact that most programs access the same data and instructions over and over. By keeping as much of this information as possible in SRAM, the computer avoids accessing the slower DRAM.

Some caches are built into the architecture of the computer's microprocessors. These internal caches are sometime called level 1 caches. Many newer computers also come with external caches sometime called level 2 caches. Level 2 caches are found between the CPU and the DRAM. Like L1 caches, L2 caches are composed of SRAM but they are much larger.

Data in memory to be read, but not modified (“read data”), is accessed by a read command. Data in memory that is to be modified (“write data”) is accessed by a write command. When the processor needs to execute an instruction or access data, it looks first in its own data registers. If the needed data is not there, the processor looks for it in the various levels of cache in the computer. If the data is not found in any cache, the CPU looks for the data in the computers main memory. If the data is not there, the computer retrieves it from the hard disk or from a backup storage system.

A computer may fetch the data from a simple disk drive as part of system, or it may fetch it from an external storage server. This external storage server may have a redundant array of independent disks (RAID) and might include from two to hundreds of drives. The Storage server may itself contain lots of memory that serves as disk cache.

When a CPU comes to the storage server to read data or write data and the data is in the large disk cache made out of DRAM, it is called a “read hit” or a “write hit” respectively. If the storage server fails to find its target data, it is called a “miss.” Every read miss introduces a delay, or latency, as the storage server must not go out and retrieve the data from the disks or disk array. When a CPU (or server) writes a sector or sectors out on the storage server with disk cache, that server will write those sectors in its memory and sometime later destage that data to disk. The storage server may make a redundant copy of this data to another controller within itself for increased availability. In fact, if the storage server makes that memory where it writes, non-volatile (for example, battery backed up) then the storage server can immediately tell the server that the write is complete even though the data is not out on the disk drive(s) yet. This is commonly called Fast Write.

Cache data may be lost if the power source fails before the data is written to the disk or disk array. However, RAM may be backed up by a battery or other secondary power source. Such RAM or other memory that is backed up by a secondary power source is referred to herein as battery-backed memory (BBM). BBM may typically be configured to maintain data for up to seventy-two hours. It is likely that by that time, the main power supply will be restored and the cache can be refreshed and moved to the disk or disk array.

In order to improve performance of the servers attached to the storage server, designers try to make the storage server cache as large as possible. Thus, to avoid losing data in these larger caches in the event of a power failure, larger batteries are needed. Along with computing speed, storage server designers place a premium on size and larger batteries are often not an option given the space limitations in computers. To increase battery size in the same amount of space would require a total redesign of the storage server architecture, which is expensive and often impractical.

From the foregoing discussion, it should be apparent that it would be an advancement in the art to provide an apparatus, system, and method that stores increased amounts of modified data on battery-backed memory. It would be a further advancement in the art to provide such an apparatus, system, and method without increasing the battery size or minimizing the increase. It would be yet another advancement in the art to provide such an apparatus, system and method without substantially altering the systems architecture. Such an apparatus, system, and method are disclosed and claimed herein.

### SUMMARY OF THE INVENTION

The present invention has been developed in response to the present state of the art, and in particular, in response to the problems and needs in the art that have not yet been fully solved by currently available storage devices. Accordingly, the present invention has been developed to provide an apparatus, system, and method for storing modified data exclusively on portions of memory backed up by a secondary power supply, that overcome many or all of the above-discussed shortcomings in the art.

The apparatus to store modified data is provided with a logic unit containing a plurality of modules configured to functionally execute the necessary steps of receiving read and write commands from a processor, storing data associated with the write command exclusively in a nonvolatile storage and in a portion of cache backed up by a battery source. Data associated with the read commands is stored in a portion of cache memory not backed up by a battery source.

These modules in the described embodiments include a battery source for supplying backup power and a memory module for storing data associated with read and write commands. In one embodiment, the memory module includes a portion backed up by the battery source and portion that is not backed up by the battery source in the event of a power failure. The modules also include a data flow module to control the data flow into and out of the memory module. The data flow module stores write or modified data exclusively in the backup portion of the memory module.

The apparatus, in one embodiment, is configured to write modified data to a memory cache. The cache resides in a portion of memory configured to store data associated with write commands and is backed up by a secondary power source which in one embodiment is a battery. The remaining portion of memory is not backed up by battery power. The cache may include a refresh module for refreshing the write command data after a power failure.

A system of the present invention will store a second copy of the data on another controller card. The system is comprised of two identical cards connected through a high-speed interconnection method. This data must also be stored in the non-volatile area of the memory system. If a power outage occurs, upon recovery, the data can be restored from the primary copy or secondary copy if the primary becomes corrupted.

A system of the present invention is also capable to store modified data. The storage server may be an embodied cache system including a processor, a memory module, data flow module, and secondary power source. In particular, the system, in one embodiment, includes a memory module operably connected to the processor. The memory module includes a cache configured to store volatile data. The memory module also includes a nonvolatile storage configured to store nonvolatile data. The cache includes a portion dedicated to data associated with write commands. The secondary power source in one embodiment is a battery configured to supply backup power in the event of a power failure. The battery supplies power to the nonvolatile storage and cache portion dedicated to data associated with write commands with backup power. A data flow module controls data flow between the processor and the memory module. The data flow module stores modified data exclusively in the backup portion of the memory module. The system also includes a date storage unit for permanently storing modified or write data.

A method of the present invention is also presented for storing modified data. The method in the disclosed embodiments substantially includes the steps necessary to carry out the functions presented above with respect to the operation of the described apparatus and system. In one embodiment, the method includes receiving one or more read command and write commands. The method may also include storing data associated with the write command in a nonvolatile storage and in a portion of a cache memory backed up by a secondary power source. The method further includes storing data associated with the read commands in a portion of a cache memory not backed up by a battery.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for storing modified data in accordance with the present invention;

FIG. 2 is a schematic block diagram of memory module apparatus suitable for use with the system of FIG. 1;

FIG. 3 is a schematic block diagram of another embodiment of a memory module apparatus suitable for use with the FIG. 1;

FIG. 4 is a schematic flow chart diagram illustrating one embodiment of a modified data storage method in accordance with the present invention; and

FIG. 5 is a schematic flow chart diagram illustrating one embodiment of a data recovery method that may be implemented on the modified data storage system of FIG. 1.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

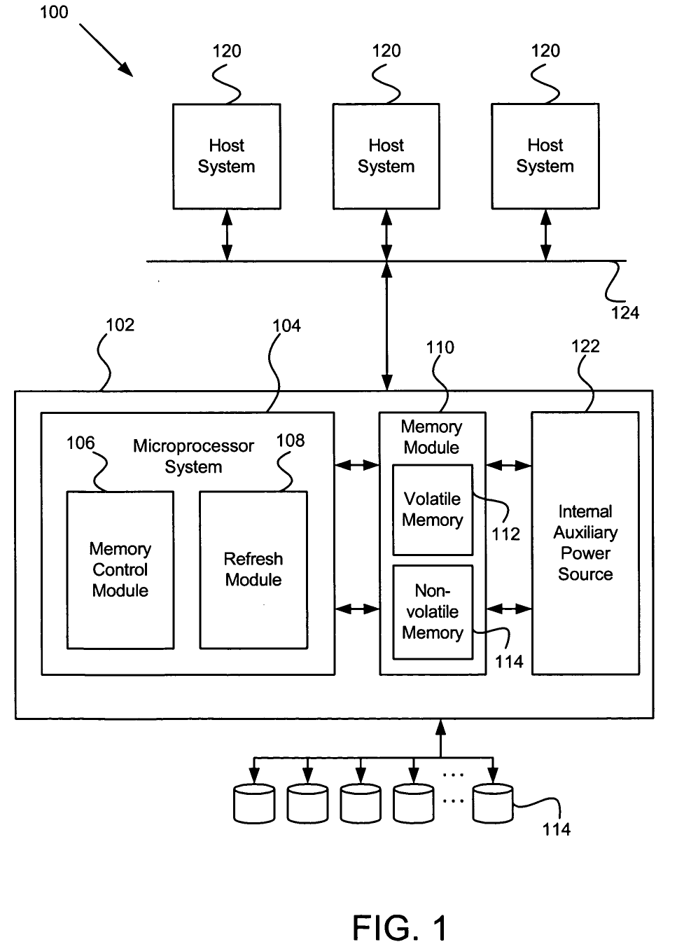

FIG. 1 illustrates a schematic block diagram of one embodiment of a representative modified data storage system 100, in accordance with the present invention. The system 100 includes a controller 102 that has a processor 104, microprocessor system 102, or another suitable logic device. The processor 104 contains a data flow module 106 and a refresh module 108. The refresh module 108 is operably connected to the memory module 110 and is configured to refresh modified data in a cache portion of the memory module 110 after a power failure.

The controller 102 also contains a memory module 110 that includes a volatile computer memory 112 as well as nonvolatile computer memory 114. In embodiment, the nonvolatile computer memory 114 includes a first nonvolatile storage. In a dual controller system, whenever data is modified in a first controller 102, a copy of that data is written to a second nonvolatile storage on the nonvolatile memory of a second controller (not shown). Thus, the nonvolatile storage or redundant data storage contains a copy of data modified by the second controller in a dual controller system. The memory module is operably connected to the processor 104. A storage server cache may reside in, or comprise a portion or the volatile memory 112. I a host 120 subsequently requests data from the storage server in this cache, the data can be delivered or updated quickly without going to an array of disk drives 116. As will be discussed in more detail below, the cache stores volatile data. The nonvolatile memory or “permanent” memory 114 stores nonvolatile data and may include a disk storage unit 116, including, but not limited to, an array of permanent storage device, a hard disk on the computer, tape storage, optical or magnetic storage devices, and the like. As discussed above, the nonvolatile memory 114 may also include a first nonvolatile storage containing a redundant copy of data modified by a second controller in a dual controller system. The system 100 may also be connected to an array of host computers 120 through a computer network 124. The host computers 102 may be in one or more locations and may execute one or more applications that may store and retrieve data on the system 100. The system 100 may also be part of a storage area network (SAN).

As will be discussed in greater detail below, the cache includes a portion of v), memory dedicated to storing modified data. The system also includes a secondary power source 122 for supplying backup power exclusively to the nonvolatile memory 114 and the portion of volatile memory 112 dedicated to storing modified data in the event of a primary power source (not shown) failure.

The data flow module 106 is operably connected to the memory module 112 and controls data flow into and out of the memory module 110. In one embodiment, the data flow module 106 facilitates the movement of data to and from the disks 116 and to and from the hosts 120. The data flow module 110 stores modified data exclusively in the cache portion of the volatile memory 112 and the nonvolatile storage. The data flow module 110 is also configured to remove modified data from the cache of the memory module 110 when becomes stale, or when the data has not been accessed for a predetermined time threshold. The data flow module 100 also removes modified data from the cache of the memory module 110 when a predetermined amount of the cache is filled.

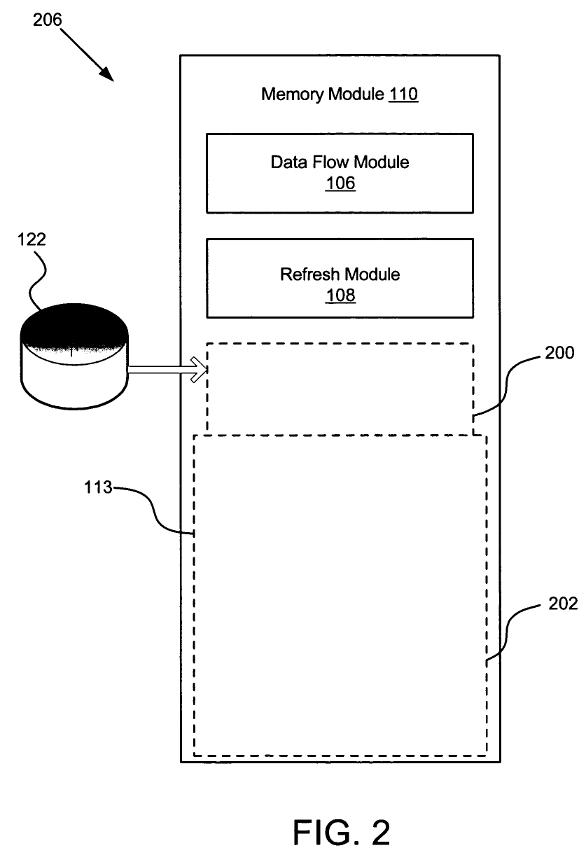

FIG. 2 illustrates a schematic block diagram depicting one embodiment of the memory module 110 of FIG. 1. The memory module 110, together with the secondary power source 122, form part of an apparatus for storing modified data. The secondary power source 122 supplies power to portions of the memory module in the event of a primary power source failure. In one embodiment, the secondary power source is a battery 122. In an alternative embodiment, the secondary power source is a fuel cell. In other embodiments, the memory storing modified data may have its own power source and not need a secondary power source. For example, the modified data may be stored on a ferrite random access memory (FRAM) or magnetic random access memory (MRAM). It will be appreciated by those of skill in the art the alternative sources of secondary power could be used to practice the teachings of this invention.

The memory module 110 includes a cache 113. The cache 113 contains a portion 208 configured to store modified data. The remaining portion 204 does not store modified data. The portion of cache 113 configured to store modified data may be referred to as write cache 208 and contain data associated with write commands or write data. The memory module 110 includes a first portion 200 and a second portion 202. The first portion 200 is configured to receive power from the secondary power source 122. The second portion 202 is not connected to the secondary power source 122. The first portion 200 of the memory module includes the portion of cache 208 configured to store unmodified data and nonvolatile memory 114.

Only the write cache 208 will contain data that has been modified but not yet written to disk 116. The read cache 204 does not contain any modified data. Read cache in one embodiment, is the portion of the computer's main memory when a command from the server or host comes in for data it may or may not be in cache 113. If it is, and it is for read data, the data can be quickly accessed. If it is not in the cache 113, it is retrieved from disk 116 and placed in read cache 204. Since read data is not modified, by definition there is already a copy of this data on the more permanent disk 116 storage. If the primary power source were to fail before retrieving this data out of read cache 204, the data would not be lost. If however a power outage occurs before the updated data in the write cache can be written to the permanent storage then that data will be lost. An unacceptable condition for a storage server. Because the cache is part of volatile data, a primary power source failure could destroy the data before it is saved.

By backing up just the portion of the cache that contains modified data, the same size of battery can now provide power to increased sizes of write cache 208 for the same length of time as batteries that back up entire caches.

In one embodiment, the portion configured to store modified data is more than about one sixty-fourth of the memory. This portion may also be configured to store less than about one eighth of the memory. In another embodiment, the portion configured to store modified data is between about one twentieth and about one sixth of the memory. In one embodiment, the cache 113 is between about one twentieth and about one sixth of the memory. As will be discussed in greater detail below, the memory may consist of a series of dynamic inline memory modules of DIMMs 300. In an eight DIMM 300 memory configuration, two of the DIMMs 300 may be dedicated to modified data in the write cache 208 and nonvolatile memory 114.

In one embodiment, the data flow module 106, and refresh module 108 may include executables that reside in the memory contained in the memory module 110. The data flow module 110 is operably connected to the memory module 100 and controls data flow into and out of the memory module 110. The data flow module 110 stores modified data or write command data exclusively in the first portion 200 of the memory module 110. The data flow module 106 directs modified data to the first portion 200 or battery-backed portion of the memory cache 113. The data flow module also directs modified data to the nonvolatile storage. In this configuration, a copy of all modified data is stored in nonvolatile storage as a part of one of the controller's nonvolatile memory. Because the secondary power source 122 keeps power to this storage 114, data stored here will not be lost during a primary power source power failure.

The data flow module 106 is configured to remove or destage data from the first portion 200 of the memory module 110 when the said data has been stored in the first portion 200 for a predetermined time threshold. Thus, when data is aged out of cache, it can be written to disk 116 and free up room in the write cache 208 for additional data. In one embodiment, the data flow module 106 ages data out of cache using a least recently used algorithm. Once write or modified data has been removed from the write cache 208, there is no need to keep its counterpart data in nonvolatile storage located in a separate controller, so the data is removed from there also. The data flow module in one embodiment removes data from non-volatile storage when modified data associated with the second controller in a dual controller system has been written to disk.

The data flow module 106 is configured to remove data from the first portion 200 of the memory module 110 when a predetermined amount of the first portion 200 has been filled with data. The data flow module 106 also stores a value associated with the largest amount of first portion 200 occupied by modified data at any given time. In effect, the data flow module 106 keeps track of a high water mark of the amount of data stored at any given time in either the cache devoted to modified data 208, the remaining portion of cache 204, or the nonvolatile storage. When the high water mark is consistently being reached, the data flow module 106 can adjust the amount of memory that is allocated for write cache 208 and nonvolatile memory 114. The data flow module 106 is able to adjust the predetermined amount of first portion 200 necessary to be filled before data is removed from the first portion 200 based upon the stored value associated with the largest amount of first portion 200 occupied by modified data. It will be appreciated by those of skill in the art that the amount of the first portion 200 to be filled before data is removed should not exceed the amount of memory that is backed up by the secondary power source. In one embodiment, data is removed according to a least recently used algorithm.

These and other means for receiving, modifying, and storing modified data exclusively on battery backed memory could be implemented to practice the teachings of this invention.

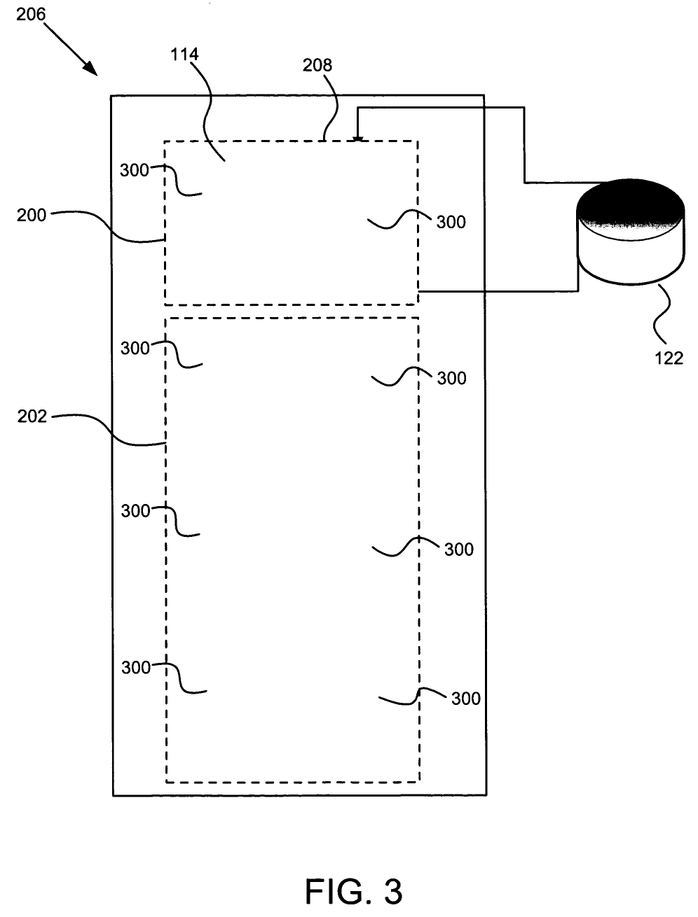

FIG. 3 illustrates one embodiment of the memory module 106. In this embodiment, eight DIMMs 300 are used for the first portion 200 and second portion 202 of the memory. Two of the DIMMS 300 comprise the first portion 200 of the memory module; one DIMM 300 for the write cache 208 and one DIMM 300 for the nonvolatile memory 114. These two DIMMS 300 are connected to the secondary power source 122 and constitute battery-backed memory. In this configuration, the present invention is able to multiply its write cache 208 memory system by a factor of four over data storage systems where all of the DIMMS 300 are backed up by a battery. In one embodiment, the controller 102 includes fewer than eight DIMMS. In another embodiment, the controller 102 includes more than eight DIMMS. In these alternative embodiments, the first two DIMMS would have access to a secondary power source and subsequent DIMMS would not. The first two DIMMS would make up the first portion 200 of memory. The system would automatically adjust the sized of write cache 208, the remaining cache 204, and the nonvolatile memory 114 to account for the increase or decrease in memory size, but not letting the write cache 208 and nonvolatile memory 114 be larger that the size of memory backed up by the secondary power source.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

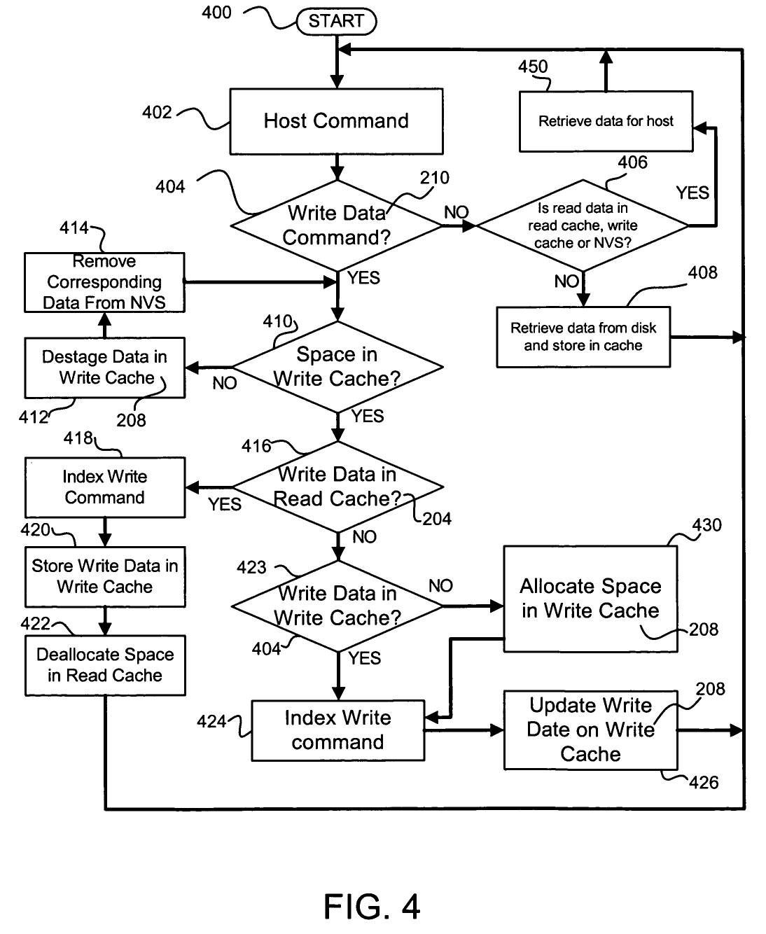

FIG. 4 depicts a schematic flow chart diagram illustrating one embodiment of a modified data storage method in accordance with the present invention. In one embodiment, the method is performed by a signal bearing medium tangibly embodying a program of machine-readable instructions executable by a digital processing apparatus to perform an operation to store modified data. The operation and method include receiving one or more read and write commands. The data associated with the write commands is then stored a portion of cache memory backed up by a battery source and written to a partner controller card's NVS area which is also backed up by a battery source. Read commands result in a search of the read cache to determine if the data is already present. If not present then the data is brought from the disk and returned to the host and stored in the read cache so that it will be there if accessed again. Thus, modified data is written to cache that is backed car up by memory and unmodified data is not.

The method may start 400 with a host command 402 received from the processor. The method then determines 404 whether the command is for write data. If it is not, the method determines 406 whether the requested data is in read cache, write cache, or nonvolatile memory. If it isn't, the data is retrieved 408 from disk. If it is, the data is simply provided 450 to the host. The method may then receive another host command 402.

If the host command is for write data a determination 410 of whether there is room in write cache 208 is made. If there is not enough space, write cache 208 is destaged 412 to disk and the corresponding data is removed 414 from the non-volatile storage (NVS). A determination 416 is made to determine if the data desired is in the read cache 204. If it is, then the system checks to see if there is space in the write cache. If there is not, it frees up a slot by destaging an entry to disk and freeing up the NVS on other side. The previously occupied space in the read cache 204 is deallocated 422 to allow more room for read data. Thus, storing data associated with the write command may include finding that write data in a portion of cache not backed up by a battery and allocating space for that data in cache backed up by a battery. The write data in this scenario, is stored in the battery-backed cache and the space in the read cache, or cache not backed up by a battery is freed or deallocated.

If the command for write data is already 423 in the write cache 208, the command is indexed 424 and the write data is updated 426 on the write cache 208 and the NVS on the other controller also updated and a new command 402 is received. If the write data is not in the read cache 204 or the write cache 208 space is allocated 430 in the write cache, the command is indexed 424, the write data is updated 426 on the write cache 208, the NVS on the other controller also updated, and a new command 402 is received. A new command could then be processed. In one embodiment, the steps 410, 412, and 414 for allocating space are not executed until after it is determined that the data requested by the host is not in cache.

Thus, storing data associated with the write command in a portion of cache memory backed up by a battery includes determining whether space exists to store the data. It also includes destaging data and freeing up the space on memory where data resided. It also includes determining if read data is being updated. If so, the read data needs to be deallocated and a new entry made in the area backed up by batteries.

For example, a host or server might desire to read 4 k of data. Both caches 204 and 208 are checked. If the data is not there, the processor may have to go to the disk 116 to get it. In actual practice, based on caching algorithms, a 64 k portion of data surrounding the 4 k requested could be staged to read cache. If the data is read data, it need not be updated and can be invalidated after use at any time because it has not been modified. It is the same version of data as what resides on the disk 116.

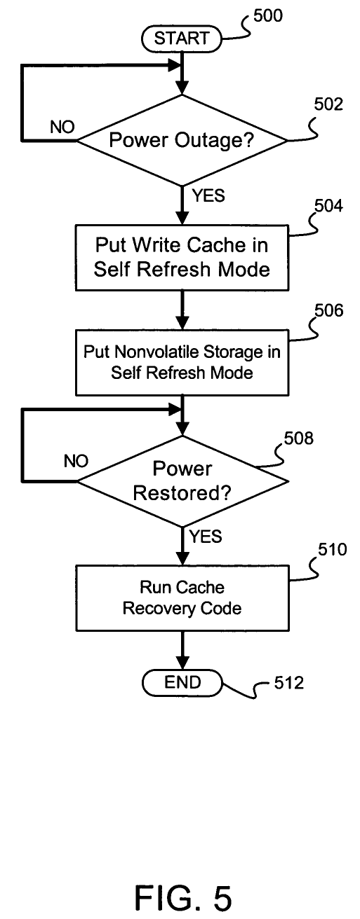

FIG. 5 depicts a schematic flow chart diagram illustrating one embodiment of a data recovery method that may be implemented on the modified data storage system 100. The method starts 500 by determining 502 whether there has been a power outage. This step is periodically repeated until it is determined that there is a power outage. On the occurrence of a primary power source failure, the write cache 208 is put 504 in self-refresh mode.

Each of the DIMMs 300 in one present embodiment of the invention have a self-refresh mode. The processor can tell each DIMM 300 holding modified write data or each DIMM 300 holding nonvolatile storage to go into self-refresh mode. In one embodiment, the DIMMs 300 are configured with refresh timers on the chips themselves and will refresh themselves. Because these DIMMs 300 are battery-backed, the rest of the subsystem can be powered off and these DIMMs 300 will maintain the contents of their memory. Even the controller can go to sleep without losing the data on these DIMMs 300.

When power is restored, the refresh module issues a command to the DIMMs 300 or portion of the memory module holding write data and nonvolatile storage and tells the memory components to come out of hibernation and start accessing them. Now a cache recovery code would start to run 510 and look at all the structures and de-stage all of the modified data, verify its accuracy, and write the data to disk. At this point, the disks 116 are completely up to date and the process ends 512.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus to store modified data, the apparatus comprising:
a secondary power source for supplying power in the event of a primary power source failure;
a memory module for storing data, the memory module comprising a first portion and a second portion, the first portion configured to receive power from the secondary power source;
a data flow module operably connected to the memory module for controlling data flow into and out of the memory module, the data flow module storing modified data exclusively in the first portion of the memory module.

2. The apparatus of claim 1, wherein the secondary power source is a battery.

3. The apparatus of claim 1, wherein the first portion of the memory module comprises a cache memory for storing modified data.

4. The apparatus of claim 1, wherein the first portion comprises a first nonvolatile storage.

5. The apparatus of claim 1, wherein the data flow module directs modified data to the memory cache of the memory module.

6. The apparatus of claim 1, wherein the data flow module copies modified data to a second nonvolatile storage.

7. The apparatus of claim 1, wherein the first portion comprises more than about one sixty-fourth of the memory module.

8. The apparatus of claim 1, wherein the first portion comprises less than about seven eighths of the memory module.

9. The apparatus of claim 1, wherein the first portion comprises between about one twentieth and about one sixth of the memory module.

10. The apparatus of claim 1, wherein the size of the first portion is automatically determined by the apparatus.

11. The apparatus of claim 1, wherein the data flow module is configured to remove data from the first portion of the memory module when said data has not been accessed for a predetermined time threshold.

12. The apparatus of claim 1, wherein the data flow module is configured to remove data from the first portion of the memory module when a predetermined amount of the first portion has been filled with data.

13. The apparatus of claim 12, wherein the data flow module stores a value associated with a largest amount of first portion occupied by modified data at any given time.

14. The apparatus of claim 12, wherein the data flow module is configured to adjust the predetermined amount of first portion necessary to be filled before data is removed from the first portion, based upon the stored value associated with the largest amount of first portion occupied by modified data.

15. A cache for storing modified data, the cache comprising:
a portion of memory configured to store modified data, said portion backed up by a secondary power source;
a portion of memory configured to store unmodified data, said portion not connected to the secondary power source; and
a refresh module for refreshing the modified data after a primary power source has failed.

16. The cache of claim 15, wherein the portion configured to store modified data comprises more than about one sixty-fourth of the memory.

17. The cache of claim 15, wherein the portion configured to store modified data comprises less than about seven eighths of the memory.

18. The cache of claim 15, wherein the portion configured to store modified data comprises between about one twentieth and about one sixth of the memory.

19. A system to store modified data, the system comprising:
a processor;
a memory module operably connected to the processor, the memory module comprising a cache configured to store volatile data, and a nonvolatile storage configured to store nonvolatile data, the cache comprising a portion of memory dedicated to storing modified data;
a secondary power source for supplying backup power, the secondary power source configured to supply power exclusively to the nonvolatile storage and cache portion dedicated to storing modified data in the event of a primary power source failure;
a data flow module operably connected to the memory module for controlling data flow between the processor and the memory module, the data flow module storing modified data exclusively in the cache and the nonvolatile storage; and
a disk storage unit.

20. The system of claim 19, further comprising a refresh module operably connected to the memory module for refreshing modified data in the cache portion after a power failure.

21. The system of claim 19, wherein the data flow module is configured to remove modified data from the cache of the memory module when said data has not been accessed for a predetermined time threshold.

22. The system of claim 19, wherein the data flow module is configured to remove modified data from the cache of the memory module when a predetermined amount of the cache is filled.

23. A signal bearing medium tangibly embodying a program of machine-readable instructions executable by a digital processing apparatus to perform an operation to store modified data, the operation comprising:
receiving one or more read and a write commands;
storing data associated with the write command in a nonvolatile storage backed up by a battery source;
storing data associated with the write command in a portion of cache memory backed up by a battery source; and
storing data associated with the read command in a portion of cache memory not backed up by a battery source.

24. The signal bearing medium of claim 23, wherein storing data associated with the write command in a portion of cache memory backed up by a battery comprises determining whether space exists to store the data.

25. The signal bearing medium of claim 232, further comprising staging certain data in the battery backed portion of memory to a disk storage unit.

26. The signal bearing medium of claim 25, further comprising freeing up the space on the battery backed portion of memory where the staged data resided.

27. A method for storing modified data, the method comprising:
receiving a read command and a write command;
storing data associated with the write command in a nonvolatile storage;
storing data associated with the write command in a portion of a cache memory backed up by a battery; and
storing data associated with the read command in a portion of a cache memory not backed up by a battery.

28. The method of claim 27, wherein storing data associated with the write command on a portion of cache memory backed up by a battery comprises determining whether space exists to store the data.

29. The method of claim 27, wherein storing data associated with the write command comprises determining whether to deallocate space associated with that data stored on a portion of cache memory not backed up by a battery.

30. The method of claim 27, wherein storing data associated with the write command comprises finding said data in a portion of cache not backed up by a battery, allocating space for said data in cache backed up by a battery, storing said data in the battery-backed cache and freeing the space in the cache not backed up by a battery where said data existed.

31. An apparatus to store modified data, the apparatus comprising:
means for receiving a read and a write command;
means for storing data associated with the write command in a nonvolatile storage;
means for storing data associated with the write command in a portion of a cache memory backed up by a battery; and
means for storing data associated with the read command in a portion of a cache memory not backed up by a battery.
